(19) United States
(12) Patent Application Publication
(10) Pub. No.: US 2006/0161537 A1
(43) Pub. Date: Jul. 20, 2006

(54) Detecting content-rich text

(75) Inventors: Einat Amitay, Shimshit (IL); Nadav Har'el, Haifa (IL)

Correspondence Address: Stephen C. Kaufman;IBM Corporation, Intellectual Property Law Dept., P.O. Box 218, Yorktown Heights, NY, 10598, US

(73) Assignee: International Business Machines Corporation, Armonk, NY (US)

(21) Appl. No.: 11/038,370

(22) Filed: Jan. 19, 2005

(51) Int. Cl. G06F 17/30

(52) U.S. Cl. 707/4

(57) ABSTRACT

A method includes finding content-rich text in a document by identifying areas of narrative in the document. An apparatus includes a detector and a content-rich text indicator. The detector detects linguistic parameters which characterize narrative text in an input document and the content-rich text indicator provides the locations of narrative text in the input document.

### FIELD OF THE INVENTION

The present invention relates to the processing of electronic text generally.

### BACKGROUND OF THE INVENTION

A principal feature of the age of information is the extraordinary volume of written material which is stored in electronic form. Internet search engines, such as Google, are widely used by individuals to perform searches of this worldwide electronic reference library. Users typically perform internet searches by providing the search engine with a keyword or keywords which summarize the subject of their search. The result returned by the search engine is a list of links to web pages in which the search engine has found the requested keywords.

Web pages have a typical layout which, as shown in FIG. 1 to which reference is now made, may include titles 12 and 14, main copy 10, menus 16 and 18, hyperlinks 20, and other elements such as advertisements, headers and footers. Web pages returned as results for an internet search may contain the keyword requested by the user in the main copy on the web page, or in a marginal element, such as a menu or advertisement. Users are typically interested in the web pages in which their keyword is mentioned in main copy 10 of the page. This is because a keyword mentioned in main copy 10 would typically be further discussed in copy 10, while a keyword located in a marginal element, such as items 12-20, would typically constitute a mere appearance of the keyword, and not a source of useful information. However, the search engine cannot make a distinction between the two types of results, and the time-consuming task of sorting out the relevant results from the irrelevant results remains to be done by the user.

Methods which have been employed to analyze web pages in order to identify main copy 10 on the page have focused on “cleaning up” the web page by using HTML markup and image analysis to remove marginal web page components, such as items 12-20. These methods have included the comparison of several pages from the same website to find template similarities, and counting the length of each segment on the page (assuming punctuation and HTML) to find the longest paragraphs in the text. These methods have proved inaccurate and insufficient as they rely on punctuation, HTML and layout.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary web page;

FIG. 2 is a block diagram illustration of an exemplary document processor, constructed and operative in accordance with a preferred embodiment of the present invention;

FIG. 3 is a block diagram illustration of an exemplary narrative text detector, useful in the document processor of FIG. 2;

FIGS. 4 and 5 are useful in understanding the operations of the narrative text detector of FIG. 3; and

FIG. 6 is the web page of FIG. 1 after being processed by the narrative text detector of FIG. 3.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

The present invention improves text processing by finding areas of interest to a user. These are found by identifying areas of narrative in the document.

There is therefore provided, in accordance with a preferred embodiment of the present invention, a method including finding content-rich text in a document by identifying areas of narrative in the document.

Additionally, in accordance with a preferred embodiment of the present invention, the identifying step includes analyzing the document for linguistic parameters which characterize narrative text.

Moreover, in accordance with a preferred embodiment of the present invention, the linguistic parameters in English are closed class words. Alternatively or in addition, the linguistic parameters may separate between semantic/content words and functional/syntactic words. The linguistic parameters may be search engine stopwords.

Further, in accordance with a preferred embodiment of the present invention, the finding step includes for each word, determining a weighted average as a function of the number of stopwords in a window around the word and selecting those words whose weighted average is above a threshold as part of the areas of narrative.

Still further, in accordance with a preferred embodiment of the present invention, the threshold is the midpoint between a minimum value and a maximum value for the weighted average. Alternatively, the threshold may be a function of a maximum score, the type of text being analyzed or the language of the document. There may be more than one threshold.

Additionally, in accordance with a preferred embodiment of the present invention, the document may be an email, a support document containing bits of code, a journal, a web page, transcribed speech, a transcribed videoed lecture, a slide or a newspaper.

Further, in accordance with a preferred embodiment of the present invention, the document may be in English or in a non-English language.

There is also provided, in accordance with a preferred embodiment of the present invention, an apparatus including a detector and a content-rich text indicator. The detector detects linguistic parameters which characterize narrative text in an input document. The content-rich text indicator provides the locations of narrative text in the input document.

Additionally, in accordance with a preferred embodiment of the present invention, the detector includes an averager to determiner for each word, a weighted average as a function of the number of stopwords in a window around the word.

Further, in accordance with a preferred embodiment of the present invention, the indicator includes a demapper to select those words whose weighted average is above a threshold as part of the areas of narrative.

Finally, there is also provided, in accordance with a preferred embodiment of the present invention, a computer product readable by a machine, tangibly embodying a program of instructions executable by the machine to perform method steps. The method steps include finding content-rich text in a document by identifying areas of narrative in the document.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that a significant distinguishing factor between main copy of a document, such as on a web page, and marginal components of the document is the style in which they are written. The main copy is written in a narrative style, which is characterized by the use of complete, structurally complex sentences, while the marginal components are written in a non-narrative style, characterized by the use of single words or sentence fragments.

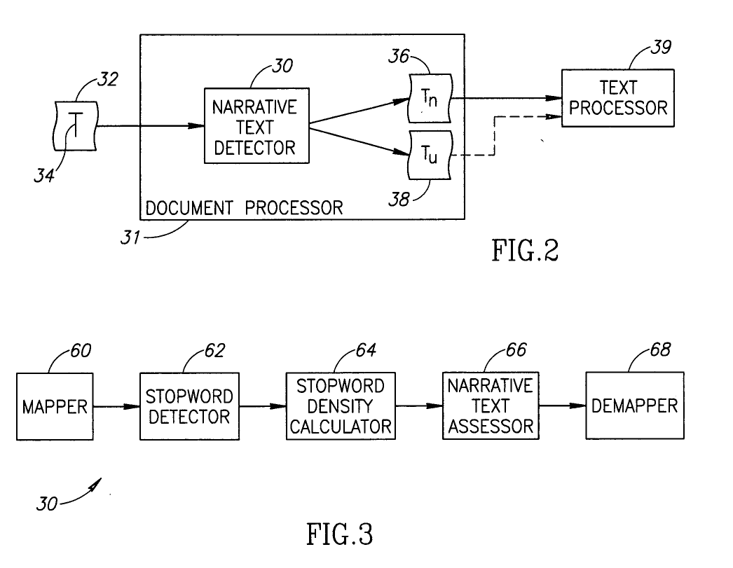

Reference is now made to FIG. 2 which illustrates an exemplary document processor 31, constructed and operative in accordance with a preferred embodiment of the present invention. Document processor 31 comprises a narrative text detector 30, which may perform an analysis of the total text 34 contained in an input document 32, and may determine which sections of the text are narrative text 36, and which sections of the text are non-narrative text 38. Narrative text 36 may be further processed by a text processor 39 according to the particular needs of the user.

Input documents 32 may be any kind of text containing any combination of narrative and non-narrative text. For example, input documents 32 could be emails with advertisements, long support documents containing bits of code, journals with advertisements, web pages, transcribed speech from call centers, transcribed videoed lectures, slides, newspapers, etc.

Text processor 39 may be any suitable type of text processor which may require a separation between narrative text 36 and non-narrative text 38.

For emails, narrative text detector 30 may find the main text of the email. Text processor 39 may then remove the headers indicating how the email was transmitted to the receiver and/or may remove the advertisements and may provide a user with just the main text of the email.

For support documents, text processor 39 may perform one type of processing for the narrative text and another type of processing on the bits of code. For videoed lectures, narrative text detector 30 may detect when the lecturer is reading text (which is typically in a formal narrative style), when he is talking extemporaneously (which is in a different narrative style) and when he is discussing bulleted slides (which is usually non-narrative) and text processor 39 may provide a different marking on the transcription or may mark up the video for each type of speech.

For web pages and other electronic documents, text processor 39 may be an internet search engine indexer which may index the keywords in the main copy (i.e. the narrative text) differently than keywords found elsewhere in the web page or document. In one exemplary embodiment, the indexer may just note that the keywords were found in the main copy.

Applicants have realized that narrative text can be identified according to particular linguistic parameters. Applicants have realized that narrative text in English contains a regular distribution of common words such as “the”, “a”, “and”, “of”, “on”, etc. In linguistic parlance, these words are known as closed class words. Closed class words are distributed evenly in English because they serve a necessary syntactic function in forming a coherent and fluent narrative. The words themselves may convey little semantic meaning, but they serve as critical building blocks in the structure of content-rich narrative text. Finding areas with a high concentration of such functional/syntactic words may identify areas of narrative text.

In contrast, non-narrative text contains few, if any, closed class words, and is content-poor. For example, headlines, advertisements, headers, footers, table of contents, and menu items are typically written in a linguistic style that is clipped and short. The purpose of these marginal document elements is generally to provide a brief introduction, description, summary or instruction, and extensive information is not provided.

| Closed Class Word Sub-category | Examples (partial lists) |
|---|---|
| Determiners | a, an, the, this, that, these, those |
| Pronouns | he, she, it |
| Auxiliary/Modal Verbs | be, have, may, can, shall, must |
| Prepositions | at, in, on, under, over, of |
| Conjunctions | and, but, or |
| Negation | no, not |

Applicants have further realized that all Indo-European languages, including German, Danish, Swedish, English, Greek, Italian, French, Portuguese, Spanish, etc. have linguistic structures such that there is a distinct separation between functional/syntactic words and semantic/content words, and that, therefore, the present invention may be implemented for these languages in an analogous manner to that described herein for the English language. Furthermore, for languages where the functional/syntactic words are not distinctly separate from the semantic/content words, such as in Semitic languages and Finno-Ugaric languages, a simple mechanism may be applied in order to separate the words into their syntactic and semantic parts, thereby allowing text in these languages to be processed by the current invention.

Applicants have realized that, for search engine indexing operations, closed class words are rejected because they are “common” and devoid of meaning and significance. In search engine parlance, closed class words are known as “stopwords”, because indexers stop the indexing process when they are encountered. Narrative text detector 30, on the other hand, may make innovative use of such rejected “chaff”.

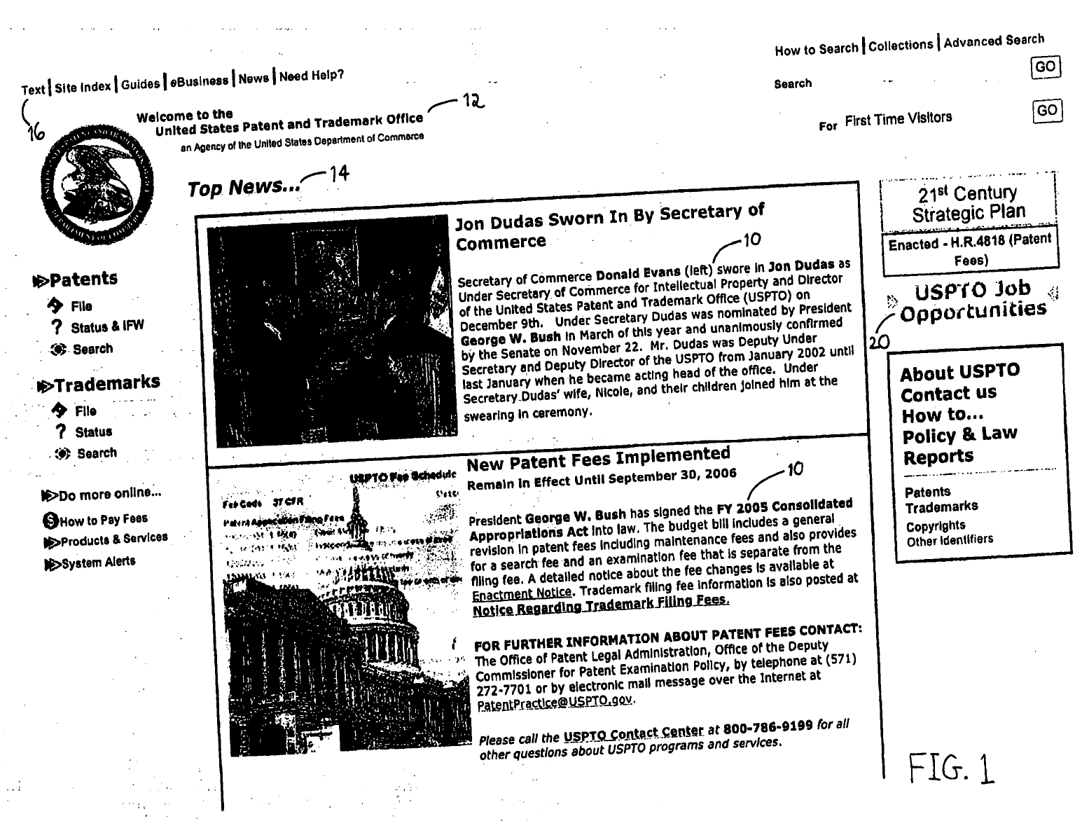

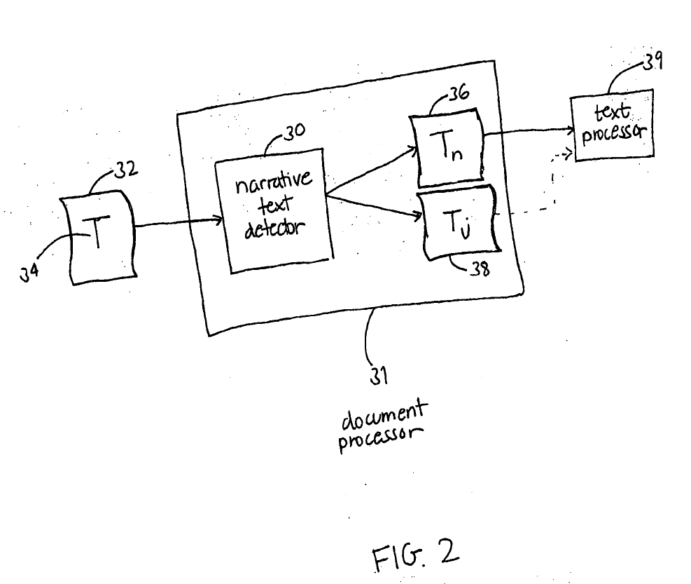

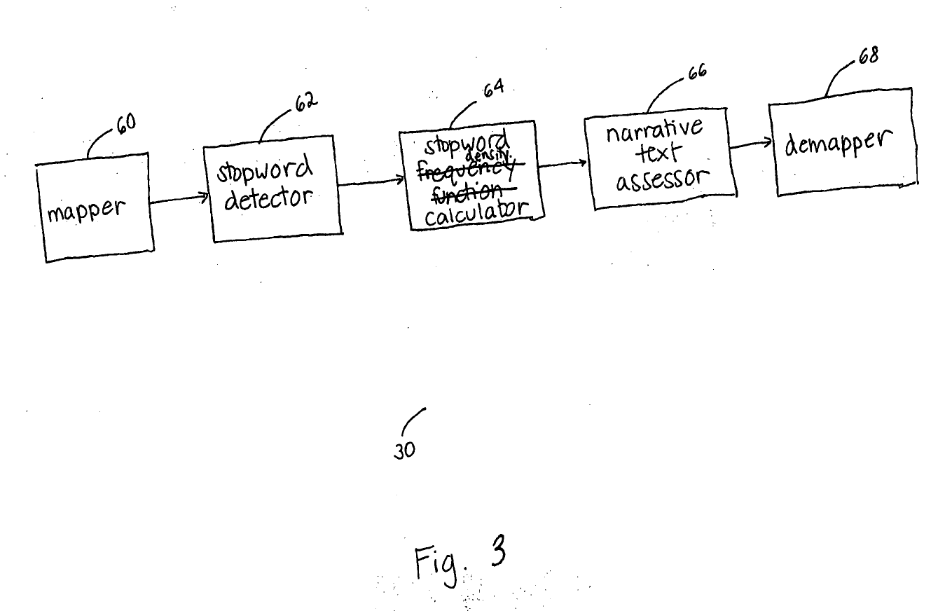

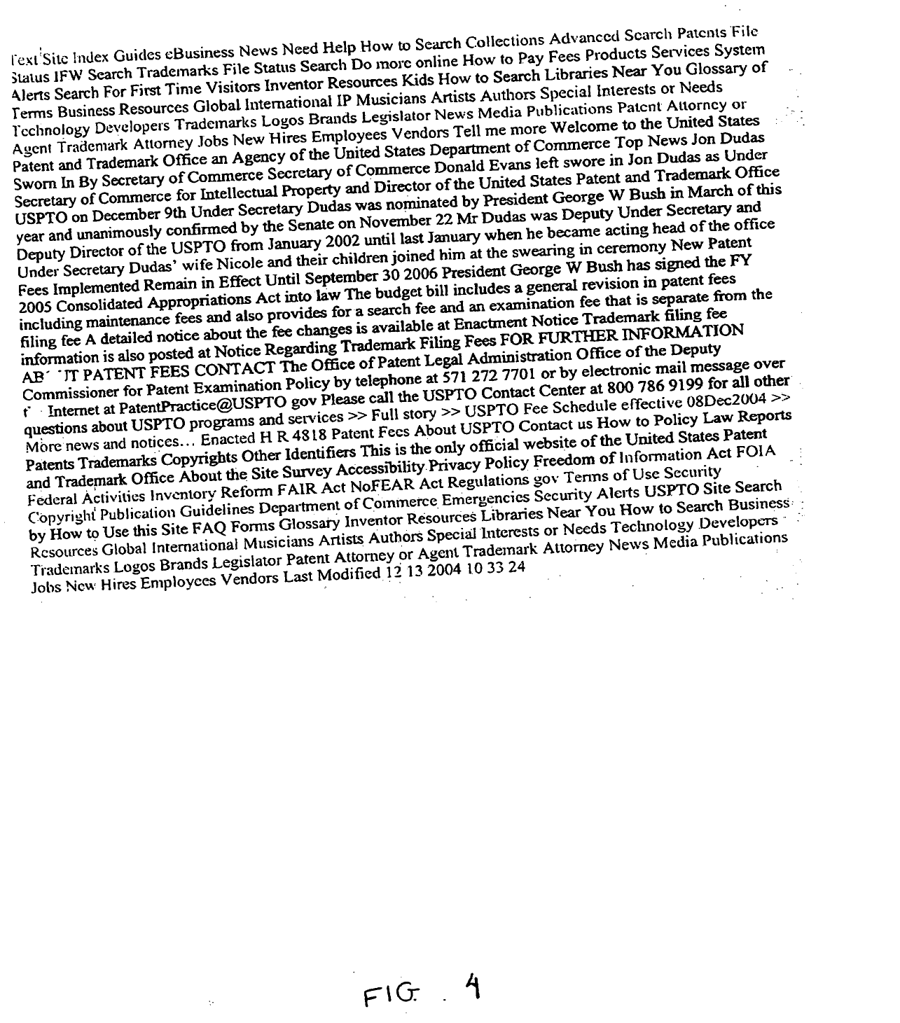

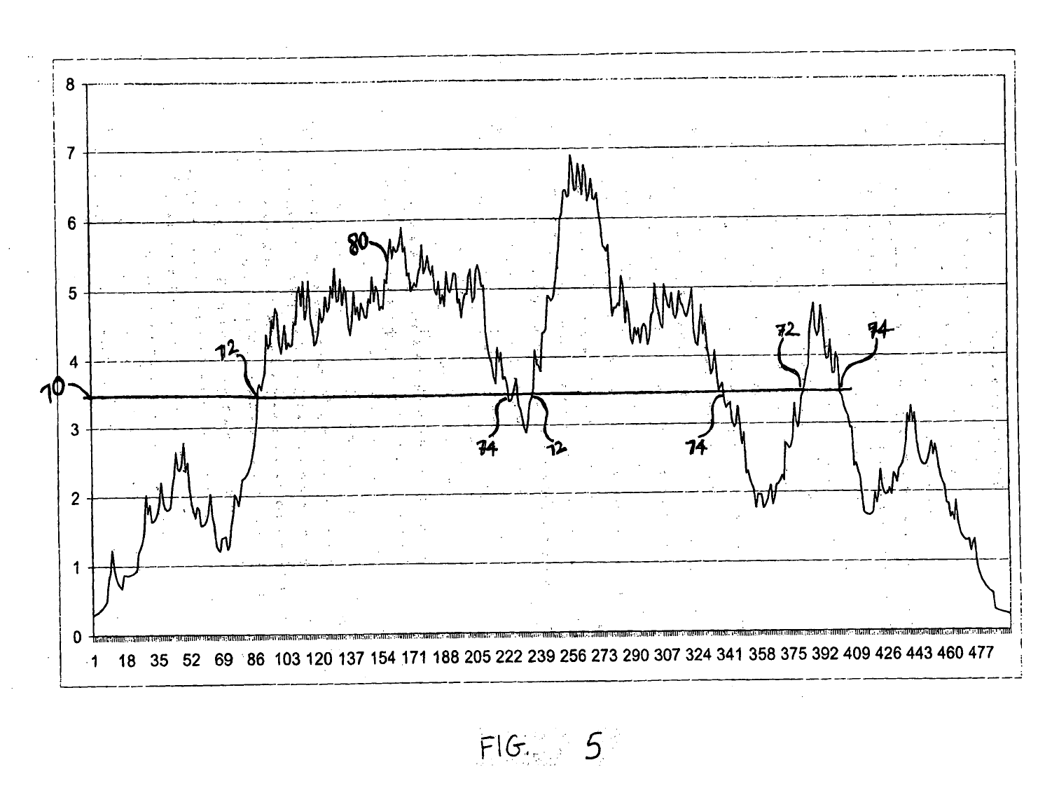

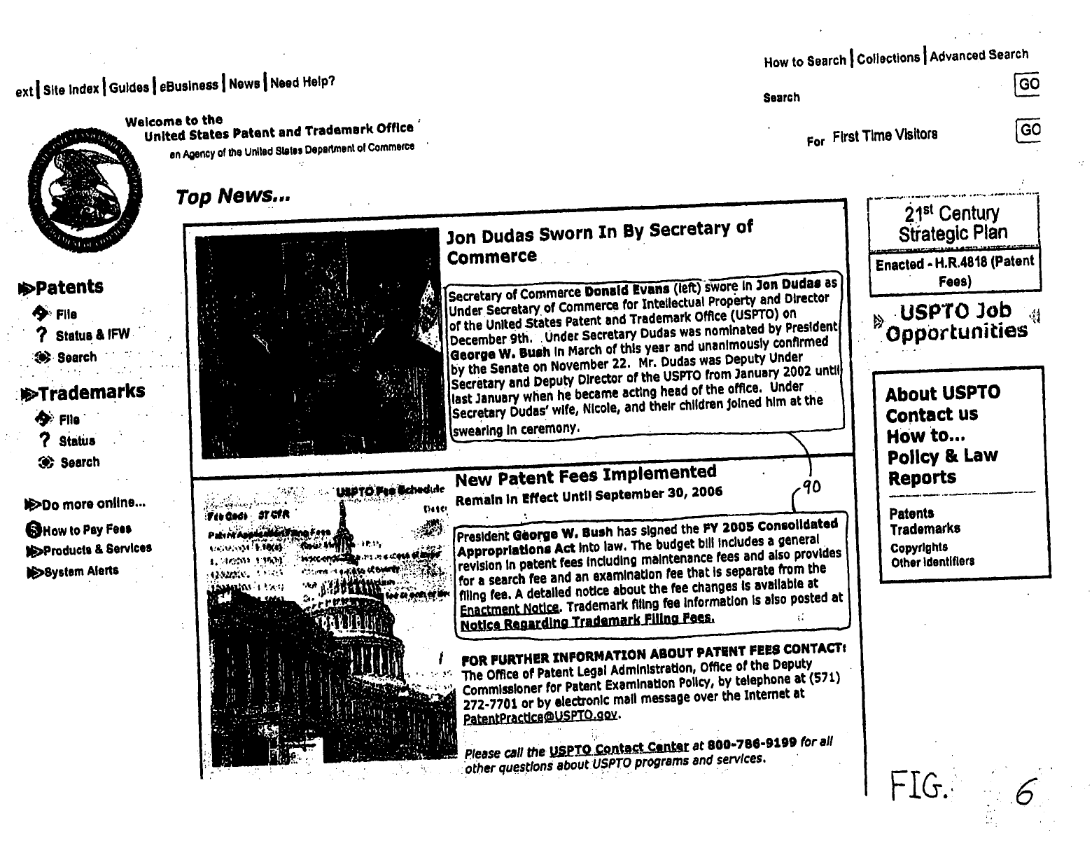

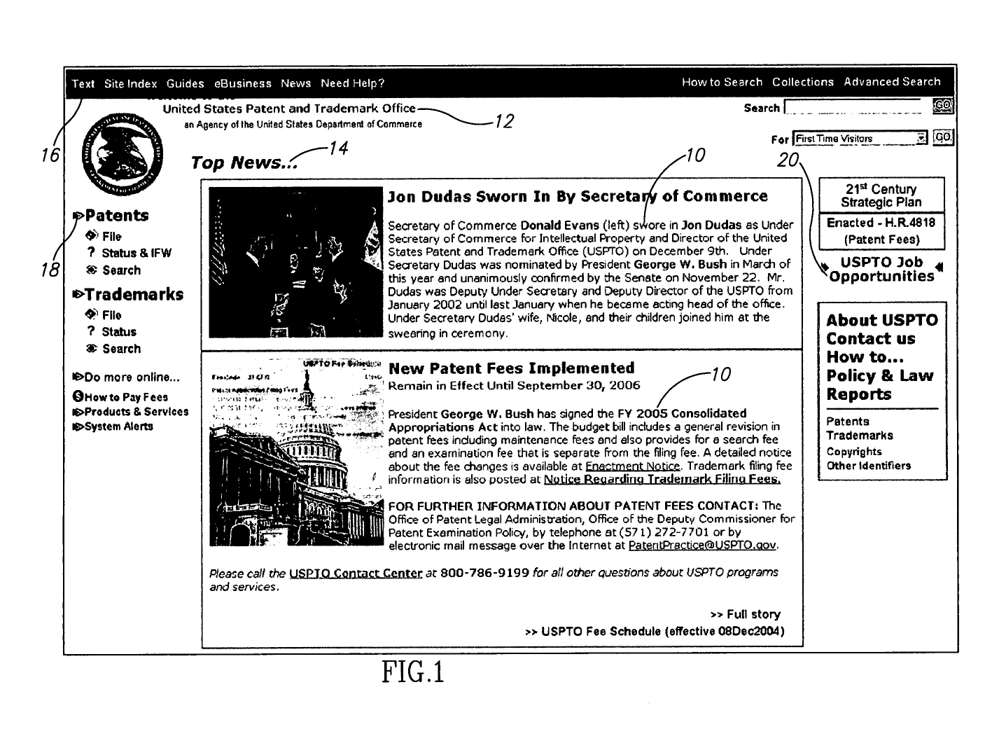

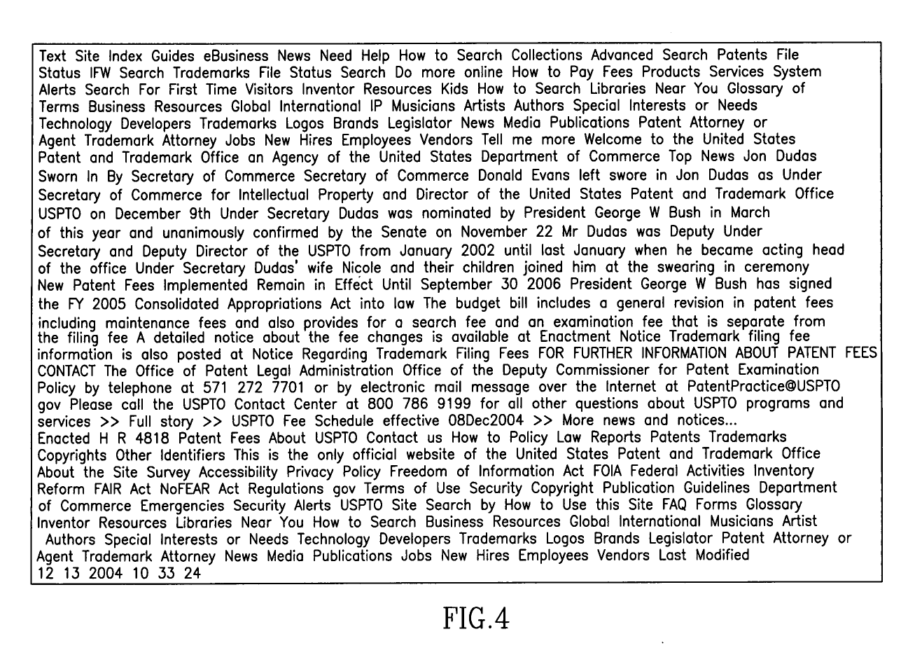

Reference is now made to FIG. 3, which details the elements of an exemplary narrative text detector 30 operating with stopwords, and to FIGS. 4, 5 and 6, which are useful in understanding the operations of the narrative text detector 30. Although narrative text detector 30 may process any type of electronic document, for clarity of explanation, FIGS. 4, 5 and 6 show the operations on the web page of FIG. 1.

Narrative text detector 30 may comprise a mapper 60, a stopword detector 62, a stopword density calculator 64, a narrative text assessor 66 and a demapper 68. Mapper 60 may translate all of the text in an input document into a single flow of text, in which each word in the input document may be identified by a unique word position number. The word position of the first word on the page is 1, the word position of the second word on the page is 2, etc. For example, FIG. 4 shows the output of mapper 60 for the web page shown in FIG. 1.

Stopword detector 62 may assign a binary value BV(i) to each ith word depending on whether or not it is a stopword. For example, it may assign a value of 1 to the word if it is a stopword, and a value of 0 if it is not a stopword. The flow of text is thus “translated” into a series of binary values representing the occurrence of stopwords and their positions in the text.

Stopword density calculator 64 may then convert the binary values BV(i) into a continuous function describing the average stopword frequency in the vicinity of each word. In one embodiment of the present invention, stopword density calculator 64 may calculate a score S(i) for a given word (the central word) which may be a reflection of the number of stopwords located within a window encompassing K words to either side of the central word. Stopword density calculator 64 may determine a weighted average of the binary values BV(i) to the (2K+1) words in the window, where stopwords closer to center of the window, i.e., closer to the central word, may have more of an impact on the score than words located further from the central word.

In one embodiment of the present invention, the formula for assigning a weight g(d) to words located at a distance d from the central word may be:

$$g ( d ) = \frac{1}{\sqrt{\vert d \vert + 1}}$$

so that the weight assigned to the central word (d=0) is g(0)=1, the weight assigned to the two words on either side of the central word (d=1) is g(1)=0.71, etc. In this embodiment, g(d) is a decreasing function for positive values of d and increasing for negative values of d, so that greater weight may be given to words nearest to the central word for which the score is being calculated. In another embodiment of the present invention, a variation of this weighted averaging function may be used.

Score S(i) for central word i may be the weighted sum of the binary values BV in the window. Mathematically this is:

$$S ( i ) = {{\sum }_{j min}}^{j max} BV ( j ) * g ( j - i ) , i = 1 , N$$

where N is the number of words in the flow of text, jmin=i−K (with a minimum value of 1) and jmax=i+K (with a maximum value of N). The resultant score S(i) is thus a measure of the stopword density in the vicinity of central word i.

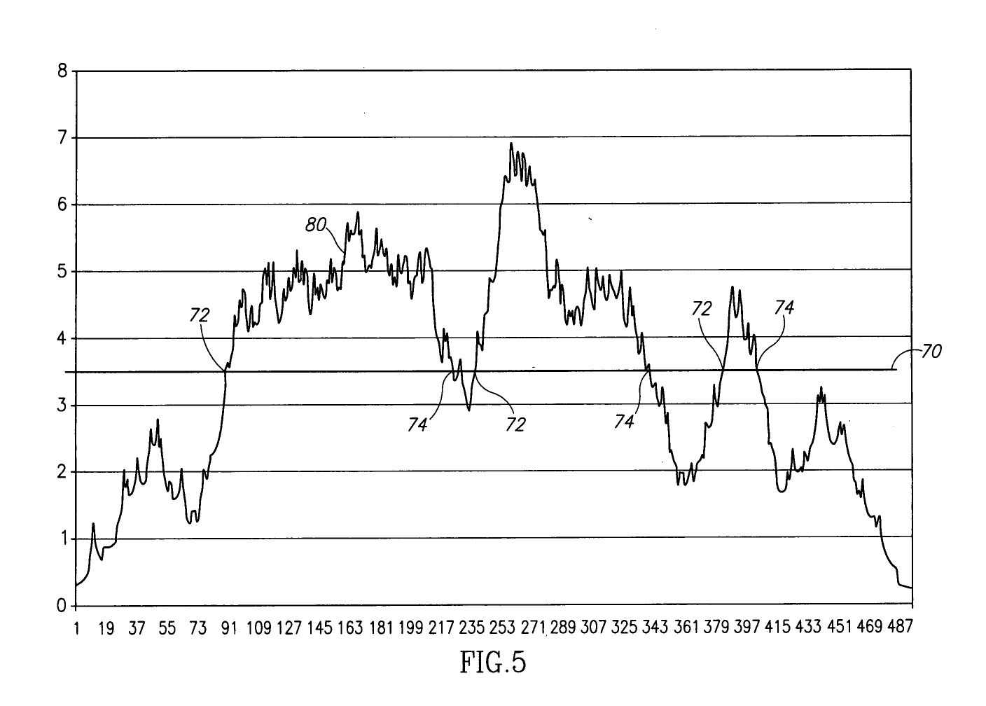

FIG. 5 shows an exemplary output of stopword density calculator 64 for the flow of text in FIG. 4. The scores S(i) of the words are plotted on the y axis against the word positions (x axis). Curve 80 represents the stopword density function for the analyzed text flow. As can be seen, curve 80 has peaks and valleys. The peak sections indicate narrative text.

Returning now to FIG. 3, the scores calculated by stopword density calculator 64 for each word in the text flow may be analyzed by narrative text assessor 66, which may determine which sections of the text flow may qualify as narrative text according to stopword density criteria.

Narrative text assessor 66 may identify sections of narrative text in accordance with any suitable method. For example, narrative text assessor 66 may identify a threshold 70, above which scores may be defined as indicative of narrative text, and below which scores may be defined as indicative of non-narrative text. As shown in FIG. 5, the designation of threshold 70 may define one or more points which may be designated as “start of narrative text” points 72, and one or more points which may be designated as “end of narrative text” points 74. Graphically, “start of narrative text” points 72 and “end of narrative text” points 74 occur where a horizontal line drawn on the graph at threshold 70 intersects curve 80.

In another embodiment of the present invention, threshold 70 may be defined as the midpoint between a minimum value and a maximum value of the curve 80, as shown in FIG. 5. In another embodiment of the present invention, threshold 70 may be calculated as a function of a maximum score M which may be the sum of g(d)*1 over the entire window, i.e.

$${\sum }_{d = 1}^{N} g ( d ) .$$

Threshold 70 may then be determined to be M/2 or 2/3M.

In a preferred embodiment of the present invention, the definition of narrative text, may be customized based on the type of text being analyzed, or the language of the text.

Alternatively, narrative text assessor 66 may have multiple thresholds defining different types of narrative style.

Still further, narrative text assessor 66 may process the stopword density function (such as curve 80) before assessing which words are narrative. In this embodiment, narrative text assessor 66 may zero the scores S(i) of words with too many below-threshold neighbors. For example, words whose neighbors are below threshold (such as less than 3 of the 5 neighbors on each side) are zeroed out. Narrative text assessor 66 may then operate on the processed curve.

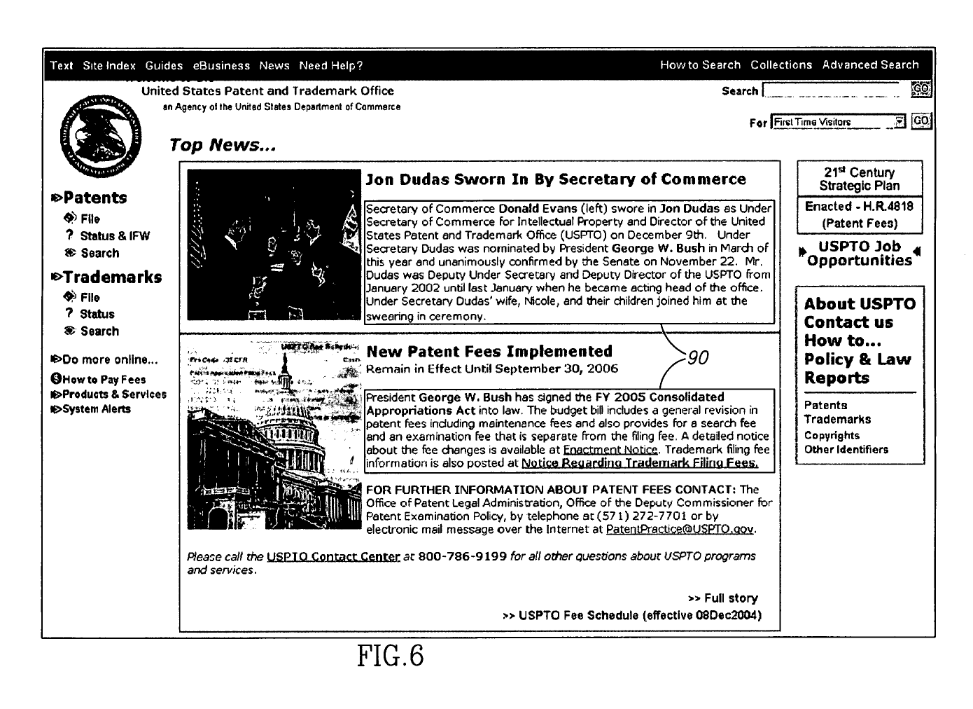

Returning now to FIG. 3, demapper 68 may receive “start of narrative text” and “end of narrative text” locations and may use them to identify where the narrative text sections are located in the input document page layout. As shown in FIG. 6, demapper 68 may indicate sections of narrative text 90 located on the web page shown in FIG. 1.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
finding content-rich text in a document by identifying areas of narrative in said document.

2. The method according to claim 1 and wherein said identifying comprises analyzing the document for linguistic parameters which characterize narrative text.

3. The method according to claim 2 and wherein said linguistic parameters in English are closed class words.

4. The method according to claim 2 and wherein said linguistic parameters separate between semantic/content words and functional/syntactic words.

5. The method according to claim 2 and wherein said linguistic parameters are search engine stopwords.

6. The method according to claim 5 and wherein said finding comprises:
for each word, determining a weighted average as a function of the number of stopwords in a window around said word; and
selecting those words whose weighted average is above a threshold as part of said areas of narrative.

7. The method according to claim 6 and wherein said threshold is the midpoint between a minimum value and a maximum value for said weighted average.

8. The method according to claim 6 and wherein said threshold is a function of at least one of the following: a maximum score, the type of text being analyzed and the language of said document.

9. The method according to claim 6 and wherein said threshold comprises more than one threshold.

10. The method according to claim 1 and wherein said document is at least one of the following types of documents: an email, a support document containing bits of code, a journal, a web page, transcribed speech, a transcribed videoed lecture, a slide and a newspaper.

11. The method according to claim 1 and wherein said document is in English.

12. The method according to claim 1 and wherein said document is in a non-English language.

13. An apparatus comprising:
a detector to detect linguistic parameters which characterize narrative text in an input document; and
a content-rich text indicator to provide the locations of narrative text in said input document.

14. The apparatus according to claim 13 and wherein said linguistic parameters in English are closed class words.

15. The apparatus according to claim 13 and wherein said linguistic parameters separate between semantic/content words and functional/syntactic words.

16. The apparatus according to claim 13 and wherein said linguistic parameters are search engine stopwords.

17. The apparatus according to claim 16 and wherein said detector comprises an averager to determiner for each word, a weighted average as a function of the number of stopwords in a window around said word.

18. The apparatus according to claim 17 and wherein said indicator comprises a demapper to select those words whose weighted average is above a threshold as part of said areas of narrative.

19. The apparatus according to claim 18 and wherein said threshold is the midpoint between a minimum value and a maximum value for said weighted average.

20. The apparatus according to claim 18 and wherein said threshold is a function of at least one of the following: a maximum score, the type of text being analyzed and the language of said document.

21. The apparatus according to claim 18 and wherein said threshold comprises more than one threshold.

22. The apparatus according to claim 13 and wherein said document is at least one of the following types of documents: an email, a support document containing bits of code, a journal, a web page, transcribed speech, a transcribed videoed lecture, a slide and a newspaper.

23. The apparatus according to claim 13 and wherein said document is in English.

24. The apparatus according to claim 13 and wherein said document is in a non-English language.

25. A computer product readable by a machine, tangibly embodying a program of instructions executable by the machine to perform method steps, said method steps comprising:
finding content-rich text in a document by identifying areas of narrative in said document.

26. The product according to claim 25 and wherein said identifying comprises analyzing the document for linguistic parameters which characterize narrative text.

27. The product according to claim 26 and wherein said linguistic parameters in English are closed class words.

28. The product according to claim 26 and wherein said linguistic parameters separate between semantic/content words and functional/syntactic words.

29. The product according to claim 26 and wherein said linguistic parameters are search engine stopwords.

30. The product according to claim 29 and wherein said finding comprises:
for each word, determining a weighted average as a function of the number of stopwords in a window around said word; and
selecting those words whose weighted average is above a threshold as part of said areas of narrative.

31. The product according to claim 30 and wherein said threshold is the midpoint between a minimum value and a maximum value for said weighted average.

32. The product according to claim 30 and wherein said threshold is a function of at least one of the following: a maximum score, the type of text being analyzed and the language of said document.

33. The product according to claim 30 and wherein said threshold comprises more than one threshold.

34. The product according to claim 25 and wherein said document is at least one of the following types of documents: an email, a support document containing bits of code, a journal, a web page, transcribed speech, a transcribed videoed lecture, a slide and a newspaper.

35. The product according to claim 25 and wherein said document is in English.

36. The product according to claim 25 and wherein said document is in a non-English language.
